(19) United States
(12) Patent Application Publication
(10) Pub. No.: US 2026/0273574 A1
(43) Pub. Date: Sep. 17, 2026

(54) Method and Apparatus for Applying Hook and Loop Fasteners to a Coated Webbing

(71) Applicant: BioThane Coated Webbing Corp, North Ridgeville, OH (US)

(72) Inventors: Alaa Tohme, North Olmsted, OH (US); Jake Zander Szaniszlo, Seven Hills, OH (US); Craig Evan Tennant, Lakewood, OH (US)

(73) Assignee: BioThane Coated Webbing Corp, North Ridgeville, OH (US)

(21) Appl. No.: 19/079,036

(22) Filed: Mar. 13, 2025

(51) Int. Cl. B05D 1/26; A44B 18/00; B29C 65/42; B29C 65/48

(52) U.S. Cl. CPC B05D 1/265; A44B 18/0073; B29C 65/42; B29C 65/4815; B05D 2201/02; B05D 2503/00; B05D 2506/25

(57) ABSTRACT

A method of applying a fastener to a webbing from a supply of fastener material and a supply of webbing material, the method comprising applying a polymer coating to the webbing material via a heated extrusion die to produce a coated webbing; applying the fastener material to the coated webbing via an applicator assembly as the coated webbing exits the heated extrusion die; and applying a force to the fastener material and the coated webbing to bond the fastener material to the coated webbing. An apparatus for applying a fastener to a coated webbing comprising a fastener feeding assembly that advances a fastener material along a fastener path; a webbing feeding assembly that advances a webbing material along a webbing path; a heated extrusion die disposed along the webbing path that applies a coating to the webbing material to produce a coated webbing; an applicator assembly disposed downstream of the fastener feeding assembly along the fastener path and downstream of the heated extrusion die along the webbing path, the applicator assembly including one or more pressure rollers arranged for applying the fastener material to the coated webbing as the coated webbing exits the heated extrusion die.

### BACKGROUND OF THE INVENTION

Hook and loop fasteners (e.g., VELCRO) are commonly adhered (bonded) to coated webbing products through secondary operations such as sewing, RF welding, hot air welding, solvent activated adhesive, glue, etc. These are manual, time-consuming processes that may leave undesirable manufacturing marks on finished products with inferior bonding at different temperatures and can require use of chemicals that can present a health threat.

Coated webbing products are typically sold to manufacturers that convert them into strap assemblies in medical, sporting goods, military/tactical/law enforcement, industrial, transportation, and pet markets. Some specific applications include (medical) orthotic straps, patient handling & transfer straps, operating room straps, patient safety straps; (military/tactical/law enforcement) police belts, waist belts, duty belts, holster straps, magazine straps, rifle slings, soft goods straps (backpacks, bags, uniforms), etc.; (sporting goods) waist belts, backpack straps, pack straps, binding straps; (industrial) tie down straps, fastening straps; (pet products) dog collars and leashes, horse halters and bridles. Coating webbing is desirable because it is more cleanable, durable, waterproof and weldable than uncoated webbing.

Typically, sewing, RF welding, hot air welding, and solvent-activated adhesive are common technologies used to bond hook and loop to thermoplastic polyurethane (TPU), thermoplastic elastomer (TPE), and polyvinylchloride (PVC) coated webbing. These technologies require additional resources, which could be costly and time-consuming, to both manufacturer and the end user. In addition, sewing, RF welding, hot air welding, and solvent activated adhesive may leave the product aesthetically displeasing to the eye. For example, when the hook and loop is sewn to the coating webbing, this leaves stitching on the second side opposite the side to which the fastener is attached. In addition, stitching punctures and penetrates the coated webbing, which can compromise the waterproof nature of coated webbing. When the hook and loop is welded to the coating webbing, the welding leaves weld marks on the second side opposite the side to which the fastener is attached. Furthermore, for solvent activated adhesive, TPU, TPE, and PVC coated webbing surface needs cleaned with isopropanol/alcohol. For heavily contaminated substrates, using a cleaning agent such as MEK, Heptane, or Acetone may be required. These cleaning agents need proper ventilation since they are volatile and flammable. Also, long exposure to the above cleaning agents can pose health risks.

Thus, there is a need for a coated webbing that has a superior bond to the hook and loop fasteners at varied temperatures, provides a clean second surface, and does not involve any volatile and flammable chemicals endangering health.

### BRIEF SUMMARY OF THE INVENTION

The present disclosure relates to a method of applying a fastener to a webbing from a supply of fastener material and a supply of webbing material. The method includes applying a polymer coating to the webbing material via a heated extrusion die to produce a coated webbing; applying the fastener material to the coated webbing via an applicator assembly as the coated webbing exits the heated extrusion die; and applying a force to the fastener material and the coated webbing to bond the fastener material to the coated webbing.

The method may include the force applied to the fastener material and the coated webbing being between 1 pound and 20 pounds.

The method step of applying the fastener material to the coated webbing may include applying the fastener material to the coated webbing when the temperature of the coated webbing is 250° F. or more.

The method step of applying the fastener material to the coated webbing may include applying the fastener material using a heat-activated adhesive.

The method may include selecting the webbing material from a woven substrate or a nonwoven substrate.

The method may include selecting the webbing material from the group consisting of nylon, polyester, aramid, and a liquid crystal polymer (LCP).

The method may include coating the webbing material with a coating selected from the group consisting of polyvinylchloride (PVC), thermoplastic polyurethane (TPU), and thermoplastic elastomer (TPE).

The method step of applying the fastener material to the coated webbing may include applying the fastener material coextensively to the coated webbing.

The present disclosure further relates to an apparatus for applying a fastener to a coated webbing. An exemplary apparatus includes a fastener feeding assembly that guides a fastener material along a fastener path; an extrusion belt puller that pulls webbing material along a webbing path; a heated extrusion die along the webbing path that applies a coating to the webbing material to produce a coated webbing; an applicator assembly disposed downstream of the fastener feeding assembly along the fastener path and downstream of the heated extrusion die along the webbing path, the applicator assembly including one or more pressure rollers arranged for applying the fastener material to the coated webbing as the coated webbing exits the heated extrusion die.

The apparatus may include fastener material selected from a hook portion or a loop portion of a hook and loop fastener system. The apparatus may include the fastener path intersecting the webbing path at the applicator assembly.

The apparatus may include a pinch roller disposed under the applicator assembly whereby the one or more pressure rollers and the pinch roller cooperate to apply a force to press together the fastener material and the coated webbing as the fastener material and the coated webbing pass between the one or more rollers and the pinch roller.

The applicator assembly may include an adjustable spring loaded mechanism to modify the force to press together the coated webbing and the fastener material.

The apparatus fastener material may be applied coextensively to the coated webbing.

The apparatus may include the coated webbing being 250° F. or more when the fastener material is applied.

The fastener material may include a heat-activated adhesive.

The apparatus may include webbing material selected from a woven substrate or a nonwoven substrate.

The apparatus may include webbing material selected from the group consisting of nylon, polyester, aramid, and liquid crystal polymer (LCP).

The apparatus may include webbing material coated with a coating selected from the group consisting of polyvinylchloride (PVC), thermoplastic polyurethane (TPU), and thermoplastic elastomer (TPE).

The present disclosure further relates to a coated webbing made using the method above. The coated webbing having first and second opposing sides, including a fastener affixed to the first side, and a second side that is free of manufacturing markings. The manufacturing markings include stitching, RF weld points, hot air weld points, laser weld points, chemical solvent residue, clamping impressions, and combinations thereof.

The present disclosure further relates to a medical strap made using the method or apparatus above, the medical strap selected from the group consisting of an orthotic strap, a patient handling and transfer strap, an operating room strap, a backboard strap, a gurney strap, and a patient safety strap.

The present disclosure can further relate to a belt made using the method or apparatus above, the belt selected from the group consisting of a single layered waist belt, and a double-layered duty belt.

The present disclosure can further relate to a utility strap made using the method or apparatus above, the utility strap selected from the group consisting of a holster strap, a magazine strap, a rifle sling, a backpack strap, and a tie-down strap.

The present disclosure can further relate to an animal restraint made using the method or apparatus above, the restraint selected from the group consisting of a pet collar, a pet leash, an animal halter, and a bridle.

### BRIEF DESCRIPTION OF THE SEVERAL VIEWS OF THE DRAWING

FIG. 1 is a schematic side view of an exemplary apparatus for applying hook and loop fasteners to a coated webbing,

FIG. 2 is an enlarged view of the applicator assembly of FIG. 1,

FIG. 3 is a side view of an exemplary fastener material,

FIG. 4 is a side view of a fastener affixed to a coated webbing,

FIG. 5 is an exemplary embodiment of a waist belt made using the apparatus of FIG. 1,

FIG. 6 is an exemplary embodiment of a duty belt made using the apparatus of FIG. 1,

FIG. 7 is an exemplary embodiment of a medical strap made using the apparatus of FIG. 1, and

FIG. 8 is an exemplary embodiment of a utility strap made using the apparatus of FIG. 1.

### DETAILED DESCRIPTION OF THE INVENTION

This invention is directed to a method and apparatus that allows a strong adhesion/bonding of hook and loop to TPU, PVC, TPE coated webbing while eliminating common secondary operations such as sewing, hot air welding, RF welding, and solvent activated adhesive. The coated webbing is more durable, waterproof, and weldable than uncoated webbing. The method and apparatus allow the simultaneous application and adhesion of hook and loop to TPU, TPE, and PVC coating webbing while the coated webbing is being extruded at the die using a spring-loaded roller applicator mechanism. Using this method and apparatus, the bonding surface of TPU, TPE, and PVC does not require cleaning or prepping with any cleaning agents prior to applying the hook and loop fasteners. In addition, the method and apparatus leave the side of the coated webbing opposite the hook and loop aesthetically pleasing as a smooth surface, free of any machining or manufacturing marks. The smooth surface makes the coated webbing waterproof and easy to clean.

The method and apparatus eliminate the need for secondary operations to bond to TPU, TPE, and PVC coated webbing. The method and apparatus, in addition to strong bonding, ensures individuals are not exposed to any volatile and flammable chemicals, which ensures that no one is put in harm's way and is both time and cost saving. The method and apparatus provide significant time-and resource-savings by enabling the coated webbing and hook and loop to be processed and finished simultaneously while still maintaining superior visual and bonding strength results. In addition, the method and apparatus do not involve any volatile and flammable chemicals that endanger health.

As will be described in more detail below, the apparatus for applying a fastener to a coated webbing includes a fastener feeding assembly and a webbing feeding assembly to advance fastener and webbing material along respective paths. As used herein, the terms “fastener” and “fastener material” can be used interchangeably. A heated extrusion die applies a coating to the webbing material to produce a coated webbing. An applicator assembly that includes one or more pressure rollers applies the fastener material to the coated webbing as the coated webbing exits the heated extrusion die.

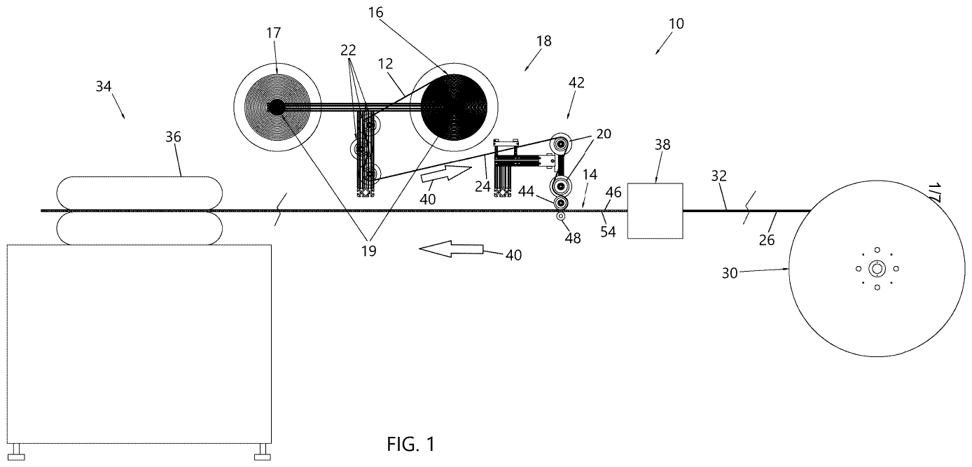

FIG. 1 shows an exemplary apparatus 10 for applying a fastener 12 to a coated webbing 14. A supply 16 of hook and loop fastener material is positioned on the apparatus and fed into the apparatus. The supply 16 can take any form convenient for feed, such as a roll. Multiple rolls, such as a subsequent secondary roll 17 can be provided to allow the operator to splice in a subsequent roll once the first roll is depleted so that the apparatus can run continuously, without shutting down the line to replace the depleted roll. The supply rolls can be held in the apparatus on spindles or tension-controlled core chucks 19. An exemplary fastener material 12 is hook and loop fasteners (VELCRO). Either a length of hook material or a length of loop material can form the supply. In other words, the apparatus can use lengths of hook or lengths of loop fasteners.

The apparatus 10 includes a fastener feeding assembly 18 that advances the fastener material 12 along a fastener path 24. The fastener feeding assembly can include at least one rotating element 36, which is driven to advance the fastener material. The fastener feeding assembly includes tension-controlled core chucks 19 to maintain tension on the fastener material 12 as it is drawn from the supply 16. The fastener feeding assembly includes one or more idler rollers 22 to help maintain tension on the fastener material 12. The tension on the fastener material 12 prevents the fastener material 12 from sagging during application.

A supply 30 of webbing material 32 is drawn into and through an extrusion die portion of the apparatus using an extrusion belt puller 36. The webbing material can be a length of woven polymer material substrate, e.g., seatbelt material, or a nonwoven substrate. The webbing material can be any polymer, e.g., nylon fibers, polyester fibers, aramid fibers, and liquid crystal polymer (LCP).

The apparatus 10 includes a webbing feeding assembly 34 that advances the webbing material 32 along a webbing path 26. The webbing feeding assembly 34 can include at least one rotating element 36 (e.g., an extrusion belt puller), which is driven to advance the webbing material 32. The webbing feeding assembly 34 draws the webbing material 32 into a heated extrusion die 38 disposed downstream 40 of the supply 30 of webbing material along the webbing path. The direction in which the material is fed into the apparatus and along a path in the apparatus will be referred to as a downstream 40 direction. An upstream direction is opposite the downstream 40 direction. The extrusion die 38 coats the webbing material 32 with a polymer such as polyvinylchloride (PVC), thermoplastic polyurethane (TPU), and thermoplastic elastomer (TPE) to produce the coated webbing 14.

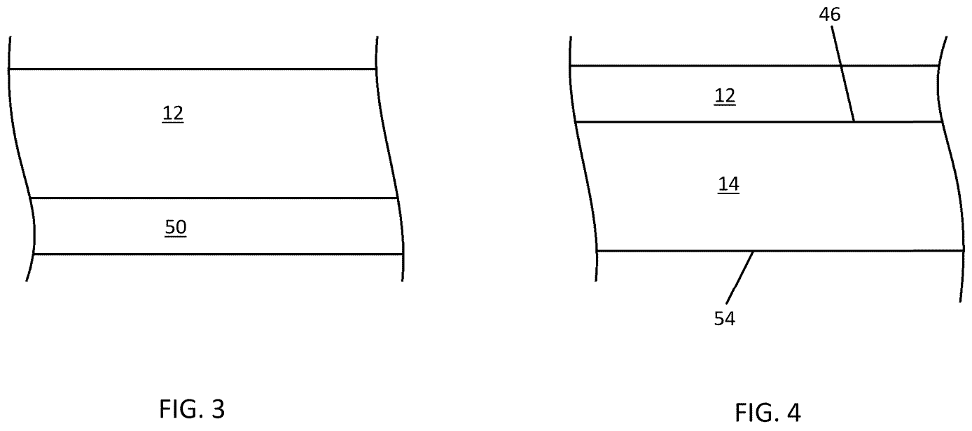

The fastener path intersects the webbing path at the applicator assembly 42. The applicator assembly 42 is disposed downstream 40 of the fastener feeding assembly 18 along the fastener path and downstream 40 of the heated extrusion die 38 along the webbing path. The applicator assembly 42 includes one or more pressure rollers 44 arranged for centering and applying the fastener material 12 to the coated webbing 14 as the coated webbing 14 exits the extrusion die 38. The spring-loaded applicator 42 is mounted on a linear slide actuator, which is used for centering the fastener material 12 on the coated webbing 14. The apparatus can include additional idler rollers 20 that help to center the fastener material. The coated webbing 14 exits the extrusion die 38 at a temperature in excess of 280° F. The coated webbing 14 passes under the applicator assembly 42, where pressure rollers 44 carrying the fastener material 12 apply the fastener material 12 to a first side 46 of the coated webbing 14. A cooperating surface, such as a plate or a pinch roller 48, is disposed under the applicator assembly 42 whereby the pressure rollers 44 and the plate or pinch roller 48 cooperate to apply a force to press together the fastener material 12 and the coated webbing 14 as the fastener material 12 and the coated webbing 14 pass between the one or more rollers 44 and the plate or pinch roller 48. The coated webbing 14 has a temperature of 250° F. or more when the applicator assembly 42 applies the fastener material 12 to the coated webbing 14. The fastener material 12 includes a heat-activated adhesive 50 (see, FIG. 3) that melts and fuses with the coated webbing 14 as the fastener 12 and coated webbing 14 are pressed together. The applicator assembly 42 applies the fastener material 12 continuously and coextensively to the coated webbing 14 as the coated webbing 14 exits the extrusion die 38. The fastener material bonds to the coated webbing and the two are drawn through the apparatus by the extrusion belt puller 36. The bond adheres the fastener material 12 to the coated webbing 14, causing the fastener material 12 to travel downstream with the coated webbing 14, which continuously draws the fastener material 12 from the supply. As noted above, tension-controlled core chucks 19 maintain tension on the fastener material 12 as it is drawn from the supply 16.

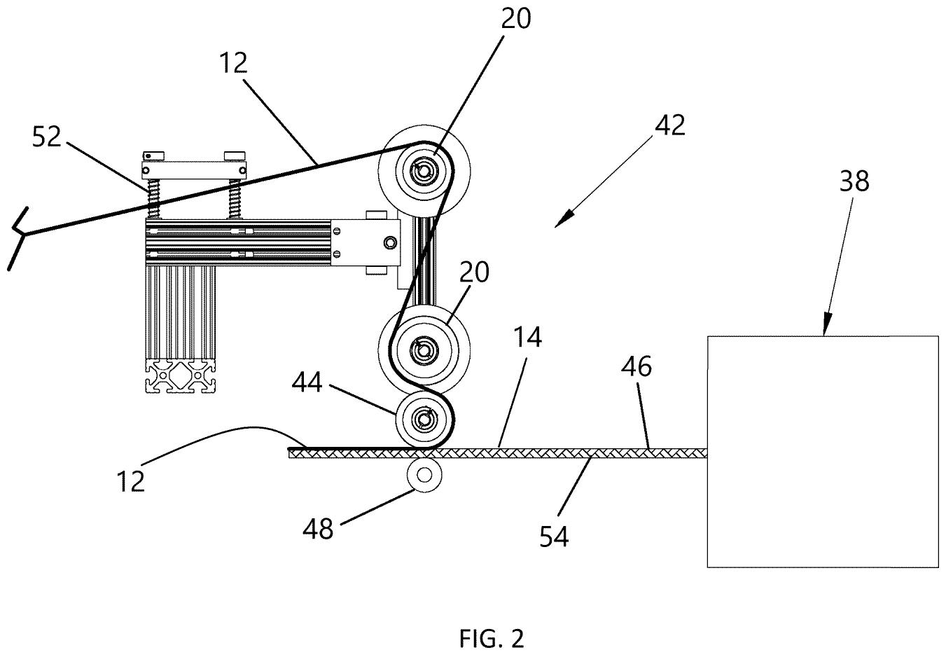

As shown in FIG. 2, the applicator assembly 42 can include a tensioning adjustment member 52 to modify the force to press together the coated webbing 14 and the fastener material 12. The tensioning adjustment member 52 can be an adjustable spring or a pneumatic/hydraulic system. The tensioning adjustment member 52 can modify the force applied to between 0 (no force applied) and 100 pounds or more, preferably between 1 pound and 20 pounds. In one embodiment, 10 pounds of force are used.

A method of applying a fastener to a coated webbing using the apparatus described herein will now be described. The method includes supplying hook and loop fastener material along a fastener path under tension. The method includes maintaining tension on the fastener material to prevent sagging during application. Either a length of hook material or a length of loop material can be used. In other words, the method can use lengths of hook or lengths of loop fasteners.

Next, the method supplies webbing material along a webbing path. The webbing material can be a length of woven polymer material substrate, e.g., seatbelt material, or a nonwoven substrate. The webbing material can be any polymer, e.g., nylon, polyester, aramid, and liquid crystal polymer (LCP). The method feeds the webbing material into an extrusion die and applies a polymer coating to the webbing material to produce a coating webbing. The coating can be a polymer such as polyvinylchloride (PVC), thermoplastic polyurethane (TPU), and thermoplastic elastomer (TPE).

The method intersects the fastener path with the webbing path where fastener material is centered and applied to the coated webbing using an applicator assembly as the coated webbing exits the extrusion die. The coated webbing exits the extrusion die at a temperature of 280° F. or more. The method includes applying the fastener material to the coated webbing at a coated webbing temperature of 250° F. or more. Then, the fastener and the coated webbing are forcefully pressed together. The method can include modifying the force to press together the coated webbing and the fastener material. The force can be modified to apply a force between 0 (no force applied) and 100 pounds or more, preferably between 1 pound and 20 pounds. The method can include using a fastener material with a heat-activated adhesive that melts and fuses with the coated webbing when the fastener and coated webbing are pressed together. The method can include adding a step of pre-heating the heat-activated adhesive. The method can include applying the fastener material continuously and coextensively to the coated webbing as the coated webbing is drawn from the extrusion die.

Thus, the method includes step (A), feeding a fastener material from a supply along a fastener feed path through an apparatus in a downstream direction, using for example the fastener feeding assembly described above. The method then includes step (B), feeding a webbing material from a supply along a webbing feed path through an apparatus in a downstream direction, using for example the webbing feeding assembly described above. The method then includes step (C), applying a polymer coating to the webbing material via a heated extrusion die to produce a coated webbing. The method then includes step (D), applying the fastener material to the hot coated webbing via an applicator assembly as the coated webbing exits the heated extrusion die, and then step (E), applying a force to the fastener material and the coated webbing to bond the fastener material to the coated webbing.

The method step (A) can include selecting from a hook portion or a loop portion of a hook and loop fastener system.

The method step (B) can include selecting the webbing material from a woven substrate or a nonwoven substrate. Step (B) can further include selecting the webbing material from nylon, polyester, aramid fibers, and Liquid Crystal Polymer (LCP).

The method step (C) can include selecting the coating from polyvinylchloride (PVC), thermoplastic polyurethane (TPU), or thermoplastic elastomer (TPE).

The method step (D) can include applying the fastener material to the coated webbing when the temperature of the coated webbing is 250° F. or more. Step (D) can further include applying the fastener material using a heat-activated adhesive. Step (D) can further include applying the fastener material coextensively with the coated webbing.

The method step (E) can be adjusted so that the force applied to the fastener material and the coated webbing is between 0 and 100 pounds or more, preferably, between 1 pound and 20 pounds.

The apparatus 10 and method produces a coated webbing (see, FIG. 4) having first and second opposing sides 46, 54, where the fastener 12 is affixed to the first side 46, and the second side 54 is clean and smooth. The bond between the fastener 12 and the first side 46 is strong and can withstand temperatures below freezing, up to oven temperatures (160° F.) without separating.

The second side 54 is free of manufacturing markings, such as stitching, RF weld points, hot air weld points, laser weld points, chemical solvent residue, and/or clamping impressions/indentations. Since the final product is used in finished products, such as belts and straps for sporting goods, pet products, medical equipment, law enforcement and military equipment, the second side is usually outward-facing and visible. Many manufacturers and customers find having manufacturing markings such as stitching and weld points to be unsightly, unprofessional, or generally aesthetically unacceptable. This visibility makes it highly desirable to have a clean, smooth surface on the second side 54.

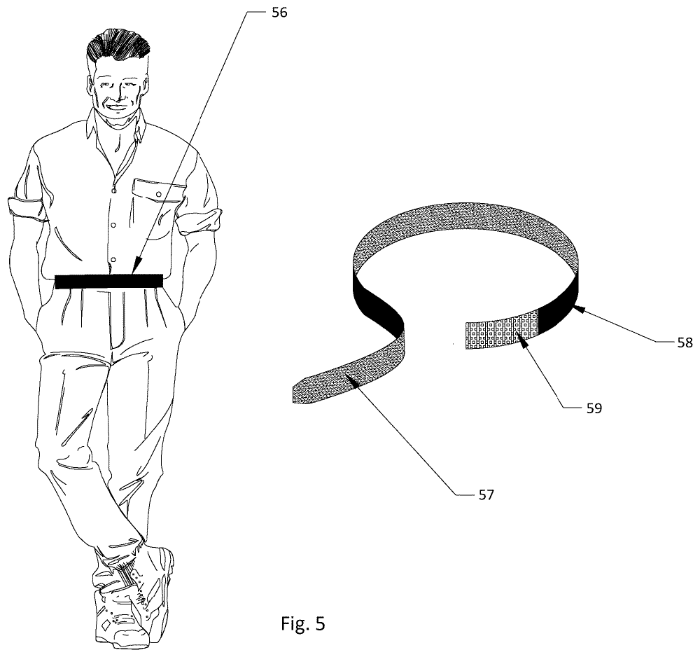

FIG. 5 shows an exemplary waist belt 56 having inner and outer faces 57,58. The inner face 57 is the first side and has a fastener affixed along its length using the method and/or apparatus described above. The outer face 58 is the smooth second side and has a discrete length of complimentary fastener 59 attached thereto. The phrase “complimentary fastener” means if the inner face has a length of hook fastener, then the complimentary fastener on the outer face is a loop fastener, and vice versa. The complimentary fastener is affixed to the belt using traditional attachment means, such as stitching, welding, or chemical adhesives, as described above. The waist belt is a single-layered belt, in contrast to the duty belt 60 described below.

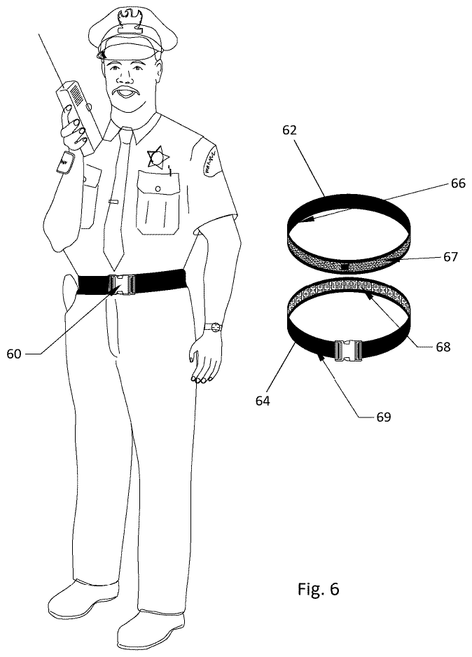

FIG. 6 shows an exemplary duty belt 60, for example, a police duty belt. The duty belt 60 is a double-layered belt that comprises an inner belt 62 and an outer belt 64. The outer belt 64 is generally wider than the inner belt 62. The inner belt has inner and outer faces 66, 67; and the outer belt has inner and outer faces 68, 69. The outer face 67 of the inner belt 62 is the first side and has a fastener affixed along its length using the method and/or apparatus described above. The inner face 66 of the inner belt 62 is the smooth second side and has a discrete length of complimentary fastener (not shown) attached thereto for fastening the inner belt to itself. The inner face 68 of the outer belt 64 is the first side and has a complimentary fastener affixed along its length using the method and/or apparatus described above. The outer face 69 of the outer belt 64 is the smooth second side and has a buckle or clasp attached thereto at one end and corresponding holes or mating clasp at the other end for connecting the ends together. In use, the inner belt 62 is fed through belt loops in the trousers and held in place by overlapping the fastener and commentary fastener. The outer belt 64 is wrapped around the body and secured to the inner belt by connecting the fastener of the inner belt 62 with the complimentary fastener of the outer belt 64. Equipment, such as an officer's equipment (e.g. radio, gun, taser, handcuffs, etc.) can be attached to the outer belt 64.

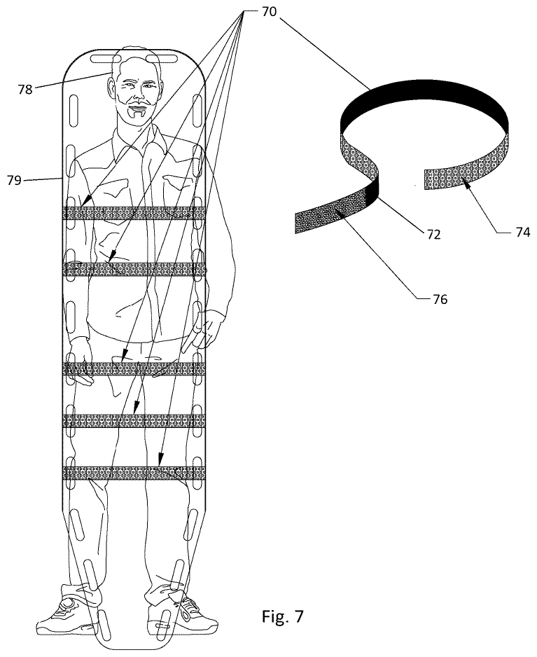

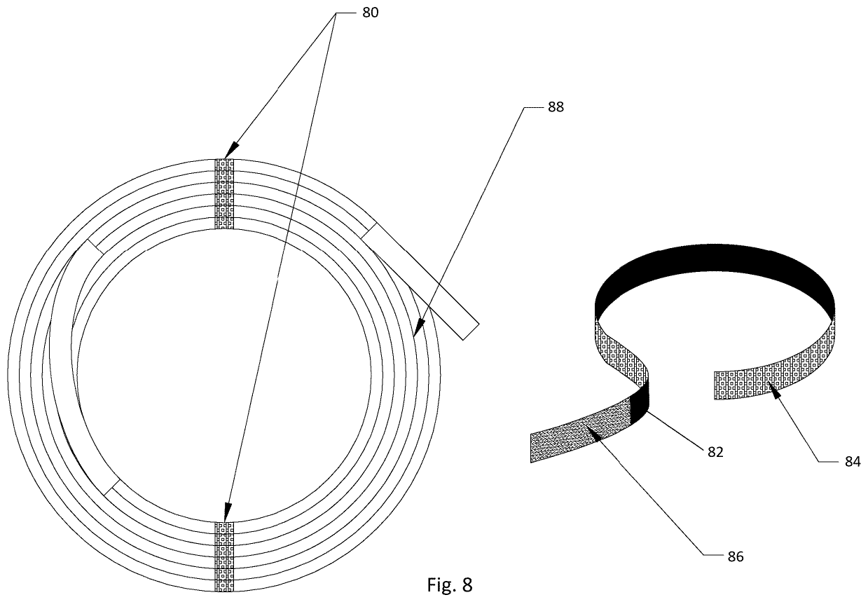

FIG. 7 shows an exemplary medical strap 70 having inner and outer faces 72,74. The outer face 74 is the first side and has a fastener affixed along its length using the method and/or apparatus described above. The inner face 72 is the smooth second side and has a discrete length of complimentary fastener 76 attached thereto. The medical strap 70 can be used for restraining a patient 78 for the patient's safety and/or for the safety of medical staff by overlapping the fastener and complimentary fastener sections. The medical strap 70 can be used with a backboard 79 or other equipment, such as a stretcher, a gurney, a hospital bed, etc. The medical strap 70 can be permanently or temporarily (i.e. removably) affixed to the backboard or other medical equipment. The medical strap 70 can include but is not limited to an orthotic strap, a patient handling and transfer strap, an operating room strap, and/or a patient safety strap.

FIG. 8 shows an exemplary utility strap 80 having inner and outer faces 82,84. The outer face 84 is the first side and has a fastener affixed along its length using the method and/or apparatus described above. The inner face 82 is the smooth second side and has a discrete length of complimentary fastener 86 attached thereto. The utility strap 80 can be used for organizing equipment, for example, as a tie-down strap for a length of hose 88 by overlapping the fastener and complimentary fastener sections; however, the utility strap 80 is not limited to hoses, and can be used to bind or fasten any items the user chooses (e.g. rope, tools, vehicle loads, tarps, tents, etc.). The utility strap 80 can also be used as a fastening strap that can include but is not limited to a holster strap, an ammunition/magazine strap, a rifle sling, and/or a backpack strap. The utility strap can also be used as an animal restraint that can include but is not limited to a pet collar, a pet leash, an animal halter, and/or a bridle.

The pinch roller 48 in the applicator assembly 42 can be replaced with an embossing roller that applies a pattern or a logo to the second side 54. As the coated webbing passes over the embossing roller, the coated webbing is pliable due to its high temperature. This pliability allows for applying a clean, crisp embossed pattern or logo. This results in an outward-facing second side 54 that has a pattern or logo, such as a company trademark/logo.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of applying a fastener to a webbing from a supply of fastener material
and a supply of webbing material, the method comprising:
applying a polymer coating to the webbing material via a heated extrusion die to produce a coated webbing;
applying the fastener material to the coated webbing via an applicator assembly as the coated webbing exits the heated extrusion die; and
applying a force to the fastener material and the coated webbing to bond the fastener material to the coated webbing.

2. The method of claim 1, wherein the force applied to the fastener material and the coated webbing is between 1 pound and 20 pounds.

3. The method of claim 1, wherein the step of applying the fastener material to the coated webbing includes applying the fastener material to the coated webbing when the temperature of the coated webbing is 250° F. or more.

4. The method of claim 1, wherein the step of applying the fastener material to the coated webbing includes applying the fastener material using a heat-activated adhesive.

5. The method of claim 1, wherein the webbing material is selected from a woven substrate or a nonwoven substrate.

6. The method of claim 1, wherein the webbing material is selected from the group consisting of nylon, polyester, aramid, and liquid crystal polymer (LCP).

7. The method of claim 1, wherein the webbing material is coated with a coating selected from the group consisting of polyvinylchloride (PVC), thermoplastic polyurethane (TPU), and thermoplastic elastomer (TPE).

8. The method of claim 1, wherein the step of applying the fastener material to the coated webbing includes applying the fastener material coextensively with the coated webbing.

9. An apparatus for applying a fastener to a coated webbing comprising
a fastener feeding assembly that advances a fastener material along a fastener path;
a webbing feeding assembly that advances a webbing material along a webbing path;
a heated extrusion die disposed along the webbing path that applies a coating to the webbing material to produce a coated webbing;
an applicator assembly disposed downstream of the fastener feeding assembly along the fastener path and downstream of the heated extrusion die along the webbing path, the applicator assembly including one or more pressure rollers arranged for applying the fastener material to the coated webbing as the coated webbing exits the heated extrusion die.

10. The apparatus of claim 9, wherein the fastener material is selected from a hook portion or a loop portion of a hook and loop fastener system.

11. The apparatus of claim 9, wherein the fastener path intersects the webbing path at the applicator assembly.

12. The apparatus of claim 9, further comprising a pinch roller disposed under the applicator assembly whereby the one or more pressure rollers and the pinch roller cooperate to apply a force to press together the fastener material and the coated webbing as the fastener material and the coated webbing pass between the one or more rollers and the pinch roller.

13. The apparatus of claim 12, wherein the applicator assembly includes an adjustable spring loaded mechanism to modify the force to press together the coated webbing and the fastener material.

14. The apparatus of claim 9, wherein the coated webbing is 250° F. or more when the fastener material is applied.

15. The apparatus of claim 9, wherein the fastener material includes a heat-activated adhesive.

16. The apparatus of claim 9, wherein the webbing material is selected from a woven substrate or a nonwoven substrate.

17. The apparatus of claim 9, wherein the webbing material is selected from the group consisting of nylon, polyester, aramid, and liquid crystal polymer (LCP).

18. The apparatus of claim 12, wherein the webbing material is coated with a coating selected from the group consisting of polyvinylchloride (PVC), thermoplastic polyurethane (TPU), and thermoplastic elastomer (TPE).

19. A coated webbing made using the method of claim 1, the coated webbing having first and second opposing sides, comprising
a fastener affixed to the first side,
a second side that is free of manufacturing markings.

20. The coated webbing of claim 19, wherein the manufacturing markings are selected from the group consisting of stitching, RF weld points, hot air weld points, laser weld points, chemical solvent residue, clamping impressions, and combinations thereof.

21. A medical strap made using the method of claim 1, the medical strap selected from the group consisting of an orthotic strap, a patient handling and transfer strap, an operating room strap, a backboard strap, a gurney strap, a hospital bed strap, and a patient safety strap.

22. A belt made using the method of claim 1, the belt selected from the group consisting of a single layered waist belt, and a double-layered duty belt.

23. A utility strap made using the method of claim 1, the utility strap selected from the group consisting of a holster strap, a magazine strap, a rifle sling, a backpack strap, and a tie-down strap.
